(19) United States
(12) Patent Application Publication
(10) Pub. No.: US 2008/0199846 A1
(43) Pub. Date: Aug. 21, 2008

(54) Poultry semen extender

(76) Inventor: Julie Long, Sykesville, MD (US)

Correspondence Address: USDA, ARS, OTT, 5601 SUNNYSIDE AVE, RM 4-1159, BELTSVILLE, MD, 20705-5131, US

(21) Appl. No.: 12/069,292

(22) Filed: Feb. 8, 2008

Related U.S. Application Data
(60) Provisional application No. 60/900,473, filed on Feb. 9, 2007.

(51) Int. Cl. A01N 1/02

(52) U.S. Cl. 435/2

(57) ABSTRACT

A medium for preserving and extending the viable useful life of poultry (e.g., turkey) semen, in vitro, is provided. Semen is preserved without loss of fertility for up to about 24 hours in the medium. The medium contains di-potassium phosphate, sodium glutamate, fructose, sodium acetate, mono-potassium phosphate, potassium citrate, magnesium chloride, N-tris hydroxymethyl methyl-2-aminoethane sulfonic acid, phosphatidylcholine, and zinc, and optionally sialic acid, carnitine, serine ethanolamine phosphodiesterase, or mixtures thereof. A method for extending the fertility of poultry (e.g., turkey) semen for up to about 24 hours when held in vitro at about 5° to about 10° C., involving mixing poultry (e.g., turkey) semen containing live spermatozoa with an aqueous medium containing di-potassium phosphate, sodium glutamate, fructose, sodium acetate, mono-potassium phosphate, potassium citrate, magnesium chloride, N-tris hydroxymethyl methyl-2-aminoethane sulfonic acid, phosphatidylcholine, and zinc, and optionally at least one of sialic acid, carnitine, serine ethanolamine phosphodiesterase, or mixtures thereof.

### REFERENCE TO RELATED APPLICATION

This application claims the benefit of U.S. Provisional Application No. 60/900,473, filed 9 Feb. 2007, which is incorporated herein by reference in its entirety.

### BACKGROUND OF THE INVENTION

The present invention relates to a medium for diluting and preserving poultry (e.g., turkey) semen without critical loss in sperm viability and more particularly to a medium for extending the useful life of poultry semen. The medium contains di-potassium phosphate, sodium glutamate, fructose, sodium acetate, mono-potassium phosphate, potassium citrate, magnesium chloride, N-tris hydroxymethyl methyl-2-aminoethane sulfonic acid, phosphatidylcholine, and zinc, and optionally at least one of sialic acid, carnitine, serine ethanolamine phosphodiesterase, or mixtures thereof. The present invention also relates to a method for extending the fertility of turkey semen for up to 24 hours when held in vitro at about 5° to about 10° C. (e.g., 5° to 10° C.), involving mixing poultry (e.g., turkey) semen containing live spermatozoa with an aqueous medium containing di-potassium phosphate, sodium glutamate, fructose, sodium acetate, mono-potassium phosphate, potassium citrate, magnesium chloride, N-tris hydroxymethyl methyl-2-aminoethane sulfonic acid, phosphatidylcholine, zinc, and optionally at least one of sialic acid, carnitine, serine ethanolamine phosphodiesterase, or mixtures thereof.

Poultry semen is viscous and highly concentrated, containing sperm concentrations of 6 billion (chicken) to 12 billion (turkey) sperm per ml of ejaculate. After collection, poultry semen must be extended with buffered salt solutions, or diluents, to maintain the viability of sperm in vitro. Dilution also is advantageous in that more hens can be inseminated from a single semen sample. There are many variations in diluent compositions; however, the basic goals are to maintain pH and osmolarity, as well as provide an energy source for metabolism.

Diluents currently being used are modifications of formulas developed at least 15 years ago, and are intended for extending fresh semen rather than storing semen for longer than 6 h. Alterations in pH and provision of an aerobic environment have enabled several diluents to maintain viable turkey sperm during liquid storage at 5°-10° C. Under these conditions, commercially acceptable fertility rates are obtained from turkey sperm stored up to 6 h. Because current liquid storage protocols (6 h) do not support adequate fertility levels for the duration of the 24-26 wk long egg production season, there is a need to develop alternative diluents and/or methods specifically for liquid semen storage. Ideally, this diluent would be used at ambient temperature and maintain sperm fertilizing capacity for 24 h or longer.

### SUMMARY OF THE INVENTION

In accordance with the present invention there is provided a medium for diluting and preserving poultry (e.g., turkey) semen without critical loss in sperm viability and more particularly to a medium for extending the useful life of poultry semen. The medium contains di-potassium phosphate, sodium glutamate, fructose, sodium acetate, mono-potassium phosphate, potassium citrate, magnesium chloride, N-tris hydroxymethyl methyl-2-aminoethane sulfonic acid, phosphatidylcholine, and zinc, and optionally at least one of sialic acid, carnitine, serine ethanolamine phosphodiesterase, or mixtures thereof.

Also in accordance with the present invention there is provided a method for extending the fertility of poultry (e.g., turkey) semen for up to 24 hours when held in vitro at about 5° to about 10° C. (e.g., 5° to 10° C.), involving mixing poultry (e.g., turkey) semen containing live spermatozoa with an aqueous medium containing di-potassium phosphate, sodium glutamate, fructose, sodium acetate, mono-potassium phosphate, potassium citrate, magnesium chloride, N-tris hydroxymethyl methyl-2-aminoethane sulfonic acid, phosphatidylcholine, and zinc, and optionally at least one of sialic acid, carnitine, serine ethanolamine phosphodiesterase, or mixtures thereof.

### BRIEF DESCRIPTION OF THE DRAWINGS

FIG. 1 shows percentages of (1) non-viable, labeled sperm and (2) viable, labeled sperm during 24 h in vitro storage of turkey semen (n=4 replicates).

FIG. 2 shows mean fluorescence intensity of turkey sperm incubated with three concentrations of NBD (fluorochrome)-phosphatidycholine (0.5, 2.5, 10.0 mg/ml) at specific time-points during 24 h in vitro storage (n=4 replicates). Phosphatidylcholine uptake was dose-dependent (p<0.05).

FIG. 3 shows true fertility of 24 h-stored turkey semen supplemented with 0.0, 0.5, 2.5 or 10.0 mg/ml phosphatidycholine (n=4 replicates). For wks 1-7, fertility of each treatment was higher (p<0.05) than control semen.

FIG. 4 shows: (A) percentage of hens laying all (100%) fertile eggs after AI with control or PC-treated stored semen. For wks 2-7, more (p<0.05) hens from the 2.5 mg/ml PC were in this fertility category than any other sperm treatment group. (B) Percentage of hens laying all unfertilized eggs after AI with control or PC-treated stored semen. For wks 4 and 10, more (p<0.05) hens from the 10.0 mg/ml PC treatment were in this fertility category than any other sperm treatment group.

FIG. 5 shows true fertility of 24 h-stored turkey semen supplemented with 0.0, 0.5, 5.0 or 50.0 mM ZnCl2. For wks 1-7, fertility of the 5.0 mM treatment was higher (p<0.05) than other ZnCl2 treatments or control semen.

### DETAILED DESCRIPTION OF THE INVENTION

I have found that phosphatidylcholine counteracts the damaging effects of lipid peroxidation during in vitro storage for 24 h at 4° C. by providing exogenous phospholipids for incorporation into poultry sperm plasma membrane. Preferably zinc is also utilized.

Most turkeys throughout the world are bred by artificial insemination, not because of the genetic merit to be gained through artificial insemination but primarily because the size of the turkey male attained through genetic selection makes them unable to perform natural mating. Much effort is made to use a suitable diluent for extending semen in order to reduce production costs. Methods to store semen for at least about 24 hours (e.g., at least 24 hours) would help to attain this objective. Consequently, intensive investigations have been made to determine what components and conditions are required for extending and preserving both chicken and turkey semen.

A number of synthetic solutions that extend as well as aid in semen preservation have been formulated and tested. It has been determined that components selected for semen extenders should provide exogenous energy sources, proper osmotic balance, sufficient buffering capacity, control of bacterial growth, and some chelating action to protect against toxic ions.

Although it is not known which components in semen extenders are critical for the support of sperm viability during storage in vitro, it has been concluded by researchers in the field that chicken and turkey spermatozoa retain their full fertilizing ability in media having wide ranges in both osmolarity (Δ, 0.455° to 0.736° C.) and pH level (pH 6.0 to 8.0). The optimal temperature for storing undiluted turkey semen appears to be 15° C.; even at this temperature, however, preservation without serious loss of fertilizing capacity has usually been limited to a few hours. Undiluted turkey semen is extraordinarily sensitive to temperatures above and below 15° C. Turkey spermatozoa usually perishes within a few minutes outside of the body even in its own seminal fluid. In fact, prior to U.S. Pat. No. 4,329,337, diluted turkey semen lost considerable fertilizing capacity when stored in various diluents for six hours regardless of the temperature at which it was held. This is in contrast with the fertilizing capacity of diluted chicken semen which can be maintained for 24 to 48 hours without serious loss of that capacity when stored at 2° to 5° C.

In the practice of this invention semen containing live spermatozoa is collected from birds either directly into the medium of this invention or into a tube and added to the medium and the mixture of semen and medium is stored at from about 5° to about 10° C. (e.g., 5° to 10° C.) in vitro until it is used to inseminate a plurality of female birds. The medium of this invention has the following formulation (before addition of about 0.5-2.5 mg/ml Phosphatidylcholine (PC) it is referred to as Beltsville Poultry Semen Extender (BPSE)):

| | | |
|---|---|---|
| Potassium diphosphate•3H₂O | 12.7 | g/L |
| Sodium glutamate | 8.67 | g/L |
| Fructose (anhydrous) | 5 | g/L |
| Sodium acetate•3H₂O | 4.3 | g/L |
| TES (N-tris Hydroxymethyl methyl-2-aminoethane | 1.95 | g/L |
| sulfonic acid) | | |
| Potassium citrate | 0.64 | g/L |
| Potassium monophosphate | 0.65 | g/L |
| Magnesium chloride•6H₂O | 0.34 | g/L |

In preparing the medium (without PC), sterilized glassware or other type of container is used and filtering is done in a closed system. The prepared medium is dispensed in airtight containers. The weighed amount of each constituent is put into a large beaker or other container and the aggregate of constituents is mixed for about 30 to 60 minutes with 900 ml of distilled water. The pH of the medium is adjusted to 6.50±0.1 by addition of 12 N HCl and the osmolarity is adjusted to 350±10 m.osmols by addition of distilled water (the addition will bring the total amount of water to about 1 liter). The mixture is then filtered through a microfilter having a pore size of 0.22 millimicrons. Before packaging the medium in sterile vials or other suitable containers, it is tested by the brain-heart infusion medium technique to make certain that it does not contain any microbial contamination. The pH and osmolarity are also checked at this time. A stock solution (25 mg/ml) of lyophilized PC is prepared using the above medium as the diluent. The stock solution is passed through a mini-extruder 21 times fitted with 0.1 μm membranes to achieve unilamellar vesicles. Hydrated lipid solutions initially will form large, multi-lamellar vesicles which impact the final desired lipid concentration. After the initial pass through a membrane, the particle size distribution will tend towards a bimodal distribution. After sufficient passes through the membrane, a unimodal, normal distribution is obtained. Serial dilutions will be used to make 2× working solutions of 20 mg/ml, 5 mg/ml and 1 mg/ml that yielded the final desired PC concentrations upon 1:1 dilution of fresh semen.

In the practice of this invention the extender medium is prepared as described above. Semen is collected from a plurality of male birds either directly into the medium or into a tube and the semen then mixed with the medium. The semen and medium are mixed at a 1:1 ratio on a volume basis. The mixture of semen containing live spermatozoa and medium can be stored in vitro for up to about 24 hours (e.g., up to 24 hours) at about 5° to about 10° C. (e.g., 5° to 10° C.) without loss of fertilizing capacity. The mixture of semen and extender medium is used to inseminate a plurality of female birds.

One of the important benefits provided by this invention is the reduction in manpower required to artificially inseminate a large number of female birds. Collected semen does not have to be used immediately; it can be collected and kept for up to 24 hours without loss of fertilizing capacity before being used.

The extender medium preferably also contains at least one source of zinc at a concentration of generally about 0.1 mM to about 3 mM (e.g., 0.1-3 mM) or about 0.01 to 0.41 g/L (e.g., 0.01-0.41 g/L), preferably about 0.3 to about 1 mM (e.g., 0.3-1 mM) or about 0.04 to 0.14 g/L (e.g., 0.04-0.14 g/L), more preferably about 0.4 to about 0.7 mM (e.g., 0.4-0.7 mM) or about 0.05 to 0.1 g/L (e.g., 0.05-0.1 g/L), and most preferably about 0.5 mM (e.g., 0.5 mM) or about 0.07 g/L (e.g., 0.07 g/L). By “a source of zinc” is generally meant herein a compound in the form of Zn²⁺ ions. Suitable examples may for instance include bioavailable zinc salts, including but not limited to salts with inorganic anions such as chloride, carbonate and sulphate, but also zinc salts with organic anions such as lactate, gluconate, fructosephosphates, orotate, citrate, malate, pyruvate, etc. and complexes of zinc with an organic molecule such as an aminoacid, or bi- or tridentate compound; or any suitable combination thereof. The extender medium may also contain sialic acid, carnitine (L-carnitine hydrochloride), or serine ethanolamine phosphodiesterase, or any mixture thereof.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

The following examples are intended only to further illustrate the invention and are not intended to limit the scope of the invention as defined by the claims.

### EXAMPLES

Materials and Methods. Animals: LargeWhite breeder poults were purchased from a primary breeder and maintained under standard management conditions during the brooding and growing periods. At 28 wk of age, toms were photostimulated by increasing light exposure from a 12:12 to a 14:10 light:dark cycle to initiate semen production. Using the abdominal massage semen collection method (Burrows, W. H., and J. P. Quinn, Poult. Sci., 14: 251-254 (1935)), toms were pre-milked at 30 wk of age and then screened for semen quality at 31 and 32 wk of age prior to being designated to sperm storage treatment groups. At 32 wk of age, hens were photostimulated by increasing the daily light exposure from 6:18 to 14:10 h (light:dark) to initiate ovarian development and egg production. Hens were inseminated on Days 10 and 12 after photostimulation and then once per week for the next 12 wk of egg production. A total of 10 toms and 76 hens were used for each experimental replicate.

Semen Collection, Evaluation and Storage: Semen was collected weekly from toms and evaluated for volume, sperm concentration, sperm viability, and sperm mobility. Fresh semen was aliquoted for the control and 3 sperm treatments. Control semen was extended 1:1 with Beltsville Poultry Semen Extender (BPSE), while treated semen was extended 1:1 with BPSE supplemented with 0.5, 2.5 or 10.0 mg/ml phosphatidylcholine (PC). Extended semen was transferred to 48-well culture plates. Multiwell plates were placed in a room temperature water bath on an orbital shaker (125 rpm) and slowly cooled to 4° C. with lids loosely fitted to ensure air availability during agitation. Semen was maintained under these conditions for 24 h.

Media Preparation: A stock solution (25 mg/ml) of lyophilized PC was prepared using BPSE as the diluent. The stock solution was passed through a mini-extruder 21 times fitted with 0.1 μm membranes to achieve unilamellar vesicles. Hydrated lipid solutions initially formed large, multi-lamellar vesicles which impacted the final desired lipid concentration. After the initial pass through a membrane, the particle size distribution tended towards a bimodal distribution. After 21 passes through the membrane, a unimodal, normal distribution was obtained. Serial dilutions were used to make 2× working solutions of 20 mg/ml, 5 mg/ml and 1 mg/ml that yielded the final desired PC concentrations upon 1:1 dilution of fresh semen. An additional set of media was prepared as described above except that the media contained ZnCl₂ at either 0.5 mM, 5.0 mM, or 50 mM. New stock and working solutions of PC were prepared each week. Phosphatidylcholine Uptake: Stock and working PC solutions were prepared as previously described except PC was labeled with the fluorochrome NBD. Fresh semen was extended 1:1 to contain 0, 0.5, 2.5 or 10 mg NBD-PC and stored at 4° C. for 24 h as described above. Semen aliquots were removed at 30 min intervals during the first 4 h of storage and at 1 h intervals from 8-24 h of storage for evaluation by flow cytometry. Aliquots were diluted in PC-free BPSE to 1×10⁷ sperm/ml and counterstained with the viability probe propidium iodide (12 μM; PI). A Beckman-Coulter Epics XL-MCL Analyzer equipped with a single 488 nm excitation source was used for all flow cytometric analyses. Forward and side scatter gating were used to select single sperm from clumps and debris. The fluorescence from NBD-stained and PI-stained spermatozoa was collected in FL1 (525 nm BP) and FL3 (620 nm BP) fluorescence detectors, respectively. The percentages of NBD-stained cells and the mean NBD fluorescence intensity/cell (MnFl) of the viable sperm population was recorded from the FL1 detector output to determine the magnitude of PC incorporation into the plasma membrane. The PC uptake experiments were replicated four times using different male flocks.

Fertility Evaluation: A total of 304 hens (76/replicate) were artificially inseminated weekly with semen stored with 0.5 mg PC/ml (n=19), 2.5 mg PC/ml (n=19), 10 mg PC/ml (n=19) or without PC (control, n=19). An additional set of hens were inseminated weekly with stored semen containing 2.5 mg/ml PC and either 0.5 mM, 5.0 mM, or 50 mM ZnCl₂; prior to insemination, semen stored in the presence of ZnCl₂ was treated with EDTA to chelate Zn ions and restore sperm motility. The inseminant dose for all treatments was 150×10⁶ sperm. This sperm number is less than that typically inseminated for commercial production; however, I desired a system sufficiently sensitive to detect even small changes in fertility due to sperm treatment. Eggs were candled after 7 d of incubation to determine true fertility and allowed to hatch to determine hatchability. Fertility trials were replicated 4 times using different flocks.

Statistical Analysis: Prior to analysis, data were checked to determine if a transformation was necessary. As expected, variables scored as percents (e.g., fertility) required transformation. I used the standard variance stabilizing arcsine transformation, y=arcsine (√(x)), where x represents the data, recorded as a proportion, and y is the scale used in the analysis. This transformation stabilized the variances sufficiently to proceed with an analysis in a mixed models framework. Software for conducting mixed models analyses in non-Gaussian frameworks, e.g., logistic regression, is not yet readily available. The mixed models I developed, estimated using Proc Mixed (SAS Institute, 1999), considered sperm treatment and week of study as fixed factors, with hen as a random factor. In addition, since data were taken from the same individuals repeatedly, thus inducing correlation, I allowed for within-individual time series correlation using an autoregressive structure. To ensure that my sample size and design had sufficient power to accurately determine the effects of the sperm treatments, I did a small simulation study prior to finalizing the design. Power was reassessed once the study was complete, and I report those results below. I used the default REML estimation method in Proc Mixed. For modeling fertility, I assumed the variance on the transformed scale due to sampling eggs was 0.25/n, where n is the number of eggs/hen/week (Steele, R. G. D., and J. H. Torrie, Principles and Procedures of Statistics with Special Reference to the Biological Sciences, 1960, McGraw-Hill Book Co., New York, N.Y.).

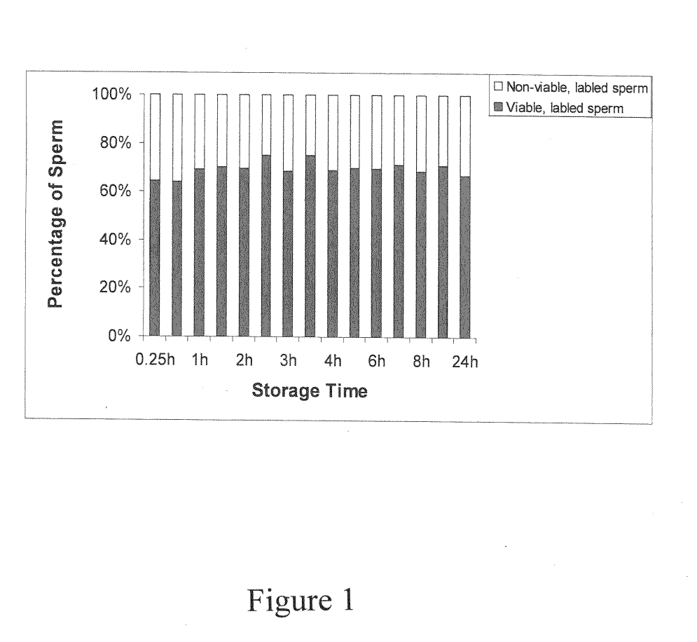

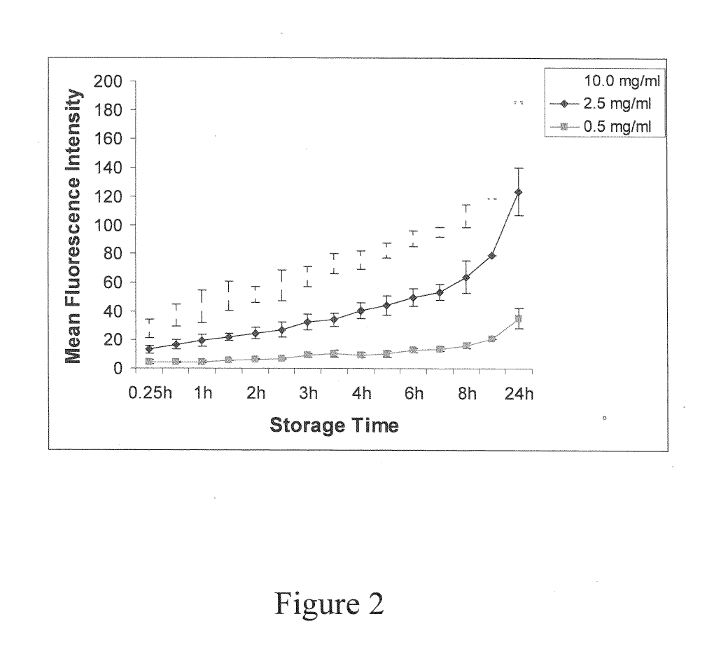

Results: Regarding phosphatidylcholine uptake, turkey sperm cells incorporated NBD-labeled PC in a dose-dependent manner during the first 12 h of storage. Most spermatozoa showed some level of PC uptake within the first 15 min of storage; however, dose-dependent differences (P<0.05) were evident in the percentage of unlabeled sperm (4.3%±0.2, 0.5 mg; 2.1%±0.3, 2.5 mg; 0.1%±0.02, 10 mg). For all other time-points, at least 98% of spermatozoa contained labeled PC, including non-viable sperm (FIG. 1). Because the magnitude of fluorescence intensity was higher for non-viable than viable sperm cells, the MnFI from the non-viable (PI-positive) sperm was excluded from further analysis. The MnFI increased sequentially at each time-point in a dose-dependent manner (FIG. 2), with a substantial increase in MnFI surprisingly evident at 24 h compared to all other time-points (P<0.05). For each PC treatment, a 2-fold increase in MnFI surprisingly occurred at 3 h of storage with 5 mg PC, and at 2.5 h of storage with 2.5 and 10 mg PC. At 4 h and 8 h of storage in 2.5 mg PC, surprisingly there were 3 and 4-fold increases in MnFI, whereas these same fold increases occurred at 6 h and 12 h, respectively, for the 0.5 and 10 mg PC treatments. At 24 h of storage, surprisingly the MnFI increased 7.8-fold for the 0.5 mg PC treatment, 9.2-fold for the 2.5 mg PC treatment, and 6.7-fold for the 10 mg PC treatment.

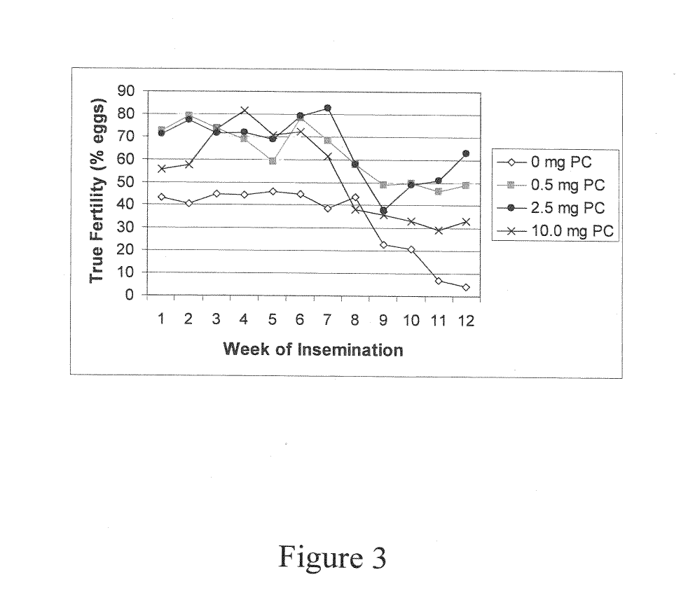

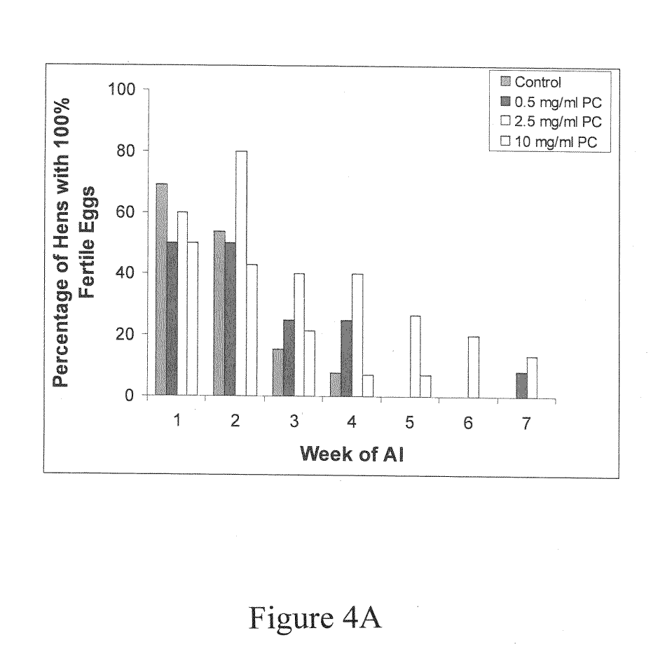

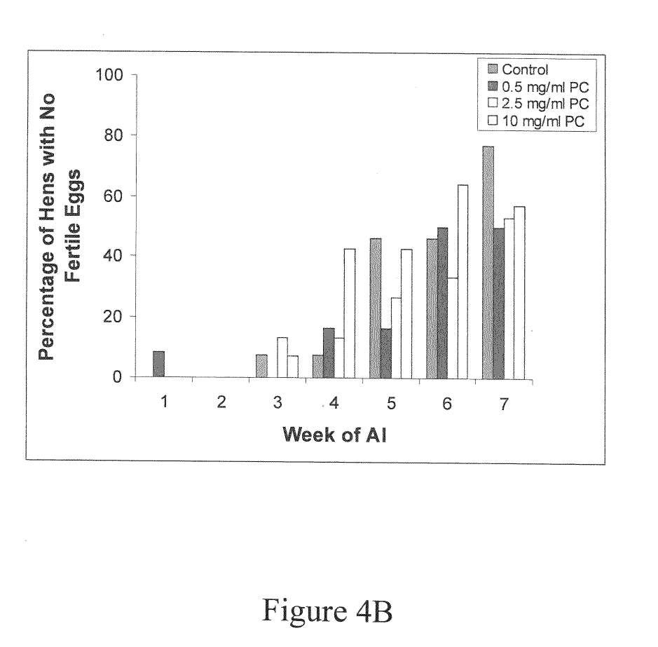

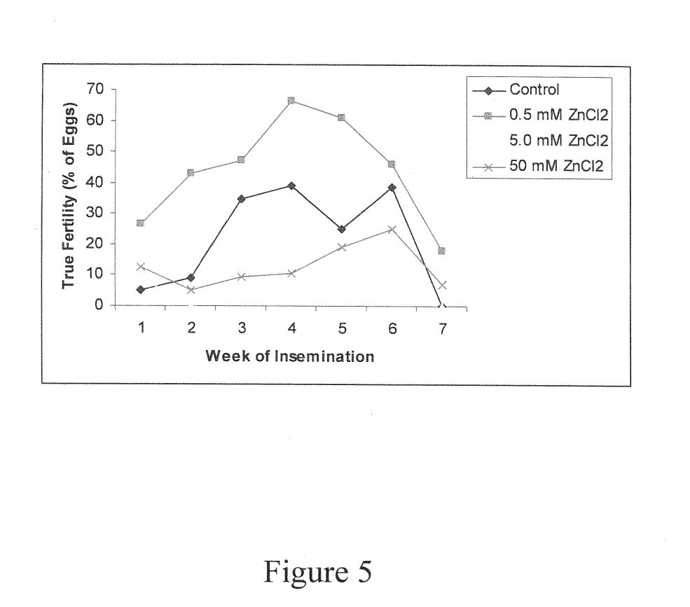

Fertility Evaluation: The mean fertility rate of eggs during the 12-wk insemination trial from control hens inseminated with fresh, non-stored semen was 91.4% 13.4. In contrast, the mean fertility rate of eggs from hens inseminated with 24 h-stored control (0 mg/ml PC) semen was 33.5%±4.5. Weekly fertility rates from this group remained stable (p>0.05) for the first 8 wks of egg production, and then declined sharply from 9-12 wks of egg production (FIG. 3). Supplementation of the extender with 0.5, 2.5 or 10.0 mg/ml PC surprisingly improved (p<0.05) the fertility rates of stored semen during the first 7 wks of egg production; however, the fertility rates obtained from the 10 mg/ml PC treatment varied widely during egg production (FIG. 3). Lower fertility rates (p<0.05) occurred in the 10 mg/ml PC treatment than the 0.5 or 2.5 mg/ml PC treatments at 1, 2 8, 10, 11, and 12 wks. Fertility rates from the 0.5 and 2.5 mg/ml PC treatments were similar (p>0.05) throughout egg production except for wks 7 and 12, where the fertility of the 2.5 mg/ml PC treatment was higher (p<0.05). Surprisingly more hens inseminated with the 2.5 mg/ml PC treatment produced 100% fertile eggs during the first 7 wks of egg production (p<0.05) than any other stored semen treatment (FIG. 4A). Interestingly, 55-62% of hens inseminated with control stored semen produced 100% fertile eggs during the first 2 wks of egg production; however, by the third wk of production, less than 20% of hens were yielding all fertile eggs. Conversely, by the seventh wk of production, 76% of hens inseminated with control stored semen were not producing any fertile eggs (FIG. 4B). Higher (p<0.05) fertility rates were surprisingly obtained with semen stored in the presence of 0.5 mM ZnCl₂ than 5.0 or 50 mM ZnCl₂ (FIG. 5).

Discussion: It has been long recognized that the ability to store turkey semen for 24 h in vitro without a significant loss in fertility upon insemination would benefit the commercial turkey industry. Using a systematic approach of identifying why and how turkey sperm lose functional competence during semen storage at 4° C., I have shown that lipid peroxidation is a major contributor to the lower fertility rates associated with stored semen. Moreover, it also has been demonstrated that the use of antioxidants in extenders does not limit the degree of lipid peroxidation during in vitro storage. Here, I present a novel supplement for turkey semen extender, phosphatidylcholine, which appears to counteract the damaging effects of lipid peroxidation.

My results demonstrated that turkey sperm membranes will incorporate exogenous phosphatidylcholine from the semen extender. During the first 12 h of in vitro storage, turkey sperm cells incorporated phosphatidylcholine in a dose-dependent manner. Most interesting was the dramatic increase in phosphatidylcholine uptake that occurred between 12 and 24 h of storage, with the 2.5 mg dose providing the largest fold increase.

Despite the initial dose-response relationship between concentration and membrane incorporation of phosphatidylcholine, this trend was not evident in the fertilizing ability of stored semen. Although superior to unsupplemented stored semen, use of 10 mg/ml phosphatidylcholine provided less predictable fertility than the other concentrations evaluated. My data suggests that either 0.5 or 2.5 mg/ml of phosphatidylcholine surprisingly improved the fertility of stored turkey semen during the first 12 wks of egg production. Further, without being bound by theory, the use of zinc to suppress sperm metabolism and motility appeared to mimic the internal environment of the hen's sperm storage tubules, and surprisingly provided another strategy to improve the fertility of turkey semen held for 24 h in vitro.

All of the references cited herein are incorporated by reference in their entirety. Also incorporated by reference in their entirety are the following references: Calif. Agric., Aug. 15, 1970; Poultry Sci., 56: 1054-1056 (1977); J. Reprod. Fert., 13: 571-575 (1967); J. Reprod. Fert., 57: 149-155 (1979); Poultry Sci., 56: 1443-1446 (1977); Beltsville Symposium in Agricultural Research No. 3, Animal Reproduction, 1979, Chapter 12, pg. 161; Bakst, M. R., Reprod. Fertil. Dev., 5: 595-599 (1993); Bakst, M. R., J. Appl. Poult. Res., 2: 373-377 (1993); Blesbois, E., et al., Theriogenology, 52: 325-334 (1999); Breque, C., et al., Mol. Reprod. Dev., 66: 314-23 (2003); Burrows, W. H., and J. P. Quinn, Poult. Sci., 14: 251-254 (1937); Cecil, H. C., and M. R. Bakst, Poult. Sci., 72: 1370-1378 (1993); Cerolini, S., et al., Poult. Avian Biol. Rev., 8:141-148 (1997); Donoghue, A. M., and G. J. Wishart, Anim. Reprod. Sci., 62: 213-232 (2000); Douard, V., et al., Biology of Reproduction, 63: 1450-1466 (2000); Douard, V., et al., Theriogenology, 9: 753-64 (2003); Douard V., et al., Theriogenology., 61:1-13 (2004); Evans, R. W., and B. P. Setchell, J. Reprod. Fertil., 53: 357-62 (1978); Fujihara, N., and B. Howarth, Jr., Poult. Sci., 57: 1766-1768 (1978); Giesen, A. F., and T. J. Sexton, Poult. Sci., 62: 379-381 (1982); Jones, R., and T. Mann, Proc. R. Soc. Lond. (Biol), 193: 317 (1976); Lake, P., Cryobiology, 15: 365-366 (1978); Lake, P. E., and O. Ravie, J. Reprod. Fertil., 57: 149-155 (1979); Long, J. A., and M. Kramer, Poult Sci., 82:1802-7 (2003); Parks, J. E., and D. V. Lynch, Cryobiology, 29: 255-266 (1992); Scott, T. W., J. Reprod. Fertil. Suppl., 18:65-76 (1973); Sexton, T. J., Comp. Biochem. Physiol., 48B: 59-65 (1974); Surai, P., et al., Poult. Avian Biol. Rev., 9: 11-23 (1998); Surai, P. F., et al., Comp. Biochem. Physiol. B. Biochem. Mol. Biol., 120: 527-33 (1998); Wishart, G. J., Br. Poult. Sci., 22: 445-450 (1981); Wishart, G., J. Reprod. Fertil., 66: 457-462 (1982); Wishart, G. J., J. Reprod. Fertil., 71:113-118 (1984); Wishart, G., and L. Carver, Comp. Biochem. Physiol., 79: 453-455 (1984). Also incorporated by reference in its entirety is U.S. Pat. No. 4,329,337.

Thus, in view of the above, the present invention concerns (in part) the following:

A medium (for extending the fertility of poultry (e.g., turkey) semen or for preserving poultry semen) for up to about 24 hours when held in vitro at about 5° to about 10° C.) comprising (or consisting essentially of or consisting of) di-potassium phosphate, sodium glutamate, fructose, sodium acetate, mono-potassium phosphate, potassium citrate, magnesium chloride, N-tris hydroxymethyl methyl-2-aminoethane sulfonic acid, phosphatidylcholine, and zinc, and optionally at least one member selected from the group consisting of sialic acid, carnitine, serine ethanolamine phosphodiesterase, and mixtures thereof.

The above medium in a mixture with turkey semen containing live spermatozoa.

The above medium further comprising water. The above medium, said medium containing about 12.7 g/L of potassium diphosphate 3H₂O, about 8.67 g/L of sodium glutamate, about 5 g/L of anhydrous fructose, about 4.3 g/L of sodium acetate 3H₂O, about 1.95 g/L of N-tris hydroxymethyl methyl-2-aminoethane sulfonic acid, about 0.64 g/L of potassium citrate, about 0.65 g/L potassium monophosphate, about 0.34 g/L of magnesium chloride 6H₂O, about 0.5-2.5 mg/ml phosphatidylcholine, and about 0.01 to 0.41 g/L source of zinc.

The above medium, said medium containing less than about 10 mg/ml phosphatidylcholine but more than 0 mg/ml phosphatidylcholine (e.g., about 0.5 to less than about 10 mg/ml phosphatidylcholine or about 0.5 to less than 10 mg/ml phosphatidylcholine).

The above medium, said medium containing about 0.5 to about 2.5 mg/ml (e.g., 0.5 to 2.5 mg/ml) of phosphatidylcholine.

The above medium, wherein said medium does not contain phosphatidylethanolamine. The above medium, wherein said medium does not contain sphingomyelin. The above medium, wherein said medium does not contain phosphatidylserine. The above medium, wherein said medium does not contain phosphatidylinositol. The above medium, wherein said medium does not contain folic acid. The above medium, wherein said medium does not contain vitamin B12. The above medium, wherein said medium does not contain lecithin. The above medium, wherein said medium does not contain surfactants.

A method for extending the fertility of poultry (e.g., turkey) semen (or a method for preserving poultry semen) for up to about 24 hours when held in vitro at about 5° to about 10° C., said method comprising (or consisting essentially of or consisting of) mixing poultry (e.g., turkey) semen containing live spermatozoa with an aqueous medium comprising (or consisting essentially of or consisting of) di-potassium phosphate, sodium glutamate, fructose, sodium acetate, mono-potassium phosphate, potassium citrate, magnesium chloride, N-tris hydroxymethyl methyl-2-aminoethane sulfonic acid, phosphatidylcholine, and zinc, and optionally at least one member selected from the group consisting of sialic acid, carnitine, serine ethanolamine phosphodiesterase, and mixtures thereof.

The above method, wherein said semen is collected from a plurality of male birds directly into said aqueous medium in a container and the mixture of semen and medium after storage in said container is used to inseminate a plurality of female birds.

Other embodiments of the invention will be apparent to those skilled in the art from a consideration of this specification or practice of the invention disclosed herein. It is intended that the specification and examples be considered as exemplary only, with the true scope and spirit of the invention being indicated by the following claims.

I claim:

1. A medium comprising di-potassium phosphate, sodium glutamate, fructose, sodium acetate, mono-potassium phosphate, potassium citrate, magnesium chloride, N-tris hydroxymethyl methyl-2-aminoethane sulfonic acid, phosphatidylcholine, and zinc, and optionally at least one member selected from the group consisting of sialic acid, carnitine, serine ethanolamine phosphodiesterase, and mixtures thereof.

2. The medium according to claim 1 in admixture with water and poultry semen containing live spermatozoa.

3. The medium according to claim 1 in admixture with water and turkey semen containing live spermatozoa.

4. The medium according to claim 1, further comprising water.

5. The medium according to claim 4, said medium containing about 12.7 g/L of potassium diphosphate 3H₂O, about 8.67 g/L of sodium glutamate, about 5 g/L of anhydrous fructose, about 4.3 g/L of sodium acetate 3H₂O, about 1.95 g/L of N-tris hydroxymethyl methyl-2-aminoethane sulfonic acid, about 0.64 g/L of potassium citrate, about 0.65 g/L potassium monophosphate, about 0.34 g/L of magnesium chloride 6H₂O, about 0.5-2.5 mg/ml phosphatidylcholine, and about 0.01 to 0.41 g/L zinc.

6. The medium according to claim 4, said medium containing 12.7 g/L of potassium diphosphate 3H₂O, 8.67 g/L of sodium glutamate, 5 g/L of anhydrous fructose, 4.3 g/L of sodium acetate 3H₂O, 1.95 g/L of N-tris hydroxymethyl methyl-2-aminoethane sulfonic acid, 0.64 g/L of potassium citrate, 0.65 g/L potassium monophosphate, 0.34 g/L of magnesium chloride 6H₂O, 0.5-2.5 mg/ml phosphatidylcholine, and 0.01 to 0.41 g/L zinc.

7. The medium according to claim 4, said medium containing less than about 10 mg/ml phosphatidylcholine.

8. The medium according to claim 4, said medium containing about 0.5 to about 2.5 mg/ml of phosphatidylcholine.

9. The medium according to claim 4, said medium containing about 0.04 to 0.14 g/L zinc.

10. The medium according to claim 4, said medium containing about 0.05 to 0.1 g/L zinc.

11. The medium according to claim 4, said medium containing about 0.07 g/L zinc.

12. A method for extending the fertility of poultry semen for up to about 24 hours when held in vitro at about 5° to about 10° C., said method comprising mixing poultry semen containing live spermatozoa with an aqueous medium comprising di-potassium phosphate, sodium glutamate, fructose, sodium acetate, mono-potassium phosphate, potassium citrate, magnesium chloride, N-tris hydroxymethyl methyl-2-aminoethane sulfonic acid, phosphatidylcholine, and zinc, and optionally at least one member selected from the group consisting of sialic acid, carnitine, serine ethanolamine phosphodiesterase, and mixtures thereof.

13. The method of claim 12, wherein said semen is collected from a plurality of male birds directly into said aqueous medium in a container and the mixture of semen and medium after storage in said container is used to inseminate a plurality of female birds.

14. The method of claim 12, wherein said poultry semen is from turkeys.

15. The method of claim 12, wherein the mixture of said semen and said aqueous medium is stored at about 5° to about 10° C.
